(19) United States
(12) Patent Application Publication
(10) Pub. No.: US 2019/0207749 A1
(43) Pub. Date: Jul. 4, 2019

(54) VALIDATING SHIPMENT BATCHES USING DISTRIBUTED LEDGER SYSTEMS

(71) Applicant: SAP SE, Walldorf (DE)

(72) Inventors: Brian Craig McKellar, Heidelberg (DE); Christian Sommer, Forst (DE)

(21) Appl. No.: 15/861,860

(22) Filed: Jan. 4, 2018

(51) Int. Cl. H04L 9/06; G06Q 30/00; H04L 9/32; G06F 21/62; H04L 29/08

(52) U.S. Cl. CPC H04L 9/0637; G06Q 30/0185; H04L 9/3242; G06K 19/06028; H04L 67/104; H04L 9/3247; G06F 21/62

(57) ABSTRACT

Implementations of the present disclosure include methods, systems, and computer-readable storage mediums for receiving encoded data including an attribute set and a first hash value that are unique to a unit, the encoded data being printed on the unit, determining a first validation hash value by processing the attribute set using a hash function of a smart contract executing on a distributed ledger system (DLS), comparing the first hash value and the first validation hash value to effect a comparison that indicates whether the attribute set of the unit is valid, and transmitting a message to a remote computing device, the message indicating whether the attribute set of the unit is valid.

### BACKGROUND

Within industry, counterfeiting of goods is problematic. For example, within the pharmaceutical industry, counterfeit pharmaceuticals is a chronic problem. This can have serious consequences (e.g., patients taking ineffective pharmaceuticals, which do not treat their condition). Although various approaches seek to inhibit counterfeiting, many such approaches are ineffective to various degrees.

### SUMMARY

Implementations of the present disclosure include computer-implemented methods for validating shipment batches using a distributed ledger system (DLS). More particularly, implementations of the present disclosure are directed to using a DLS to validate an item based on attributes associated with the item, and one or more functions executable on the DLS.

In some implementations, actions include receiving encoded data including an attribute set and a first hash value that are unique to a unit, the encoded data being printed on the unit, determining a first validation hash value by processing the attribute set using a hash function of a smart contract executing on a DLS, comparing the first hash value and the first validation hash value to effect a comparison that indicates whether the attribute set of the unit is valid, and transmitting a message to a remote computing device, the message indicating whether the attribute set of the unit is valid. Other implementations include corresponding systems, apparatus, and computer programs, configured to perform the actions of the methods, encoded on computer storage devices.

These and other implementations may each optionally include one or more of the following features: the first hash value is provided by locally processing the attribute set using the hash function; the encoded data includes the first hash value included in the attribute set; the encoded data is provided as a machine-readable code that is printed on the unit; the hash function is a public hash function that provides the first hash value, and the first validation hash value based on a secret salt value; actions further include determining a second validation hash value using the smart contract executing on the DLS, wherein validity of the attribute set if further based on comparing a second hash value and the second validation hash value; and the attribute set includes two or more of an article number, an expiration date, a batch number, a serial number, and a type.

Implementations of the present disclosure achieve one or more of the following example advantages. In one example, implementations of the present disclosure provide resource-efficient validation by avoiding maintenance and storage of relatively large data sets (e.g., attribute sets, hash values, and the like need not be stored on the DLS). Instead, the hash function is stored and executed using smart contracts on the DLS. Further, in the case of use of secret salt values, required storage space is similarly minimized.

The present disclosure also provides one or more non-transitory computer-readable storage media coupled to one or more processors and having instructions stored thereon which, when executed by the one or more processors, cause the one or more processors to perform operations in accordance with implementations of the methods provided herein.

The present disclosure further provides a system for implementing the methods provided herein. The system includes one or more processors, and a computer-readable storage medium coupled to the one or more processors having instructions stored thereon which, when executed by the one or more processors, cause the one or more processors to perform operations in accordance with implementations of the methods provided herein.

It is appreciated that methods in accordance with the present disclosure may include any combination of the aspects and features described herein. That is, methods in accordance with the present disclosure are not limited to the combinations of aspects and features specifically described herein, but also include any combination of the aspects and features provided.

The details of one or more implementations of the present disclosure are set forth in the accompanying drawings and the description below. Other features and advantages of the present disclosure will be apparent from the description and drawings, and from the claims.

### DESCRIPTION OF DRAWINGS

FIG. 1 depicts an example conceptual architecture in accordance with implementations of the present disclosure.

FIG. 2 depicts an example unit having attributes encoded in a machine-readable code printed thereon in accordance with implementations of the present disclosure.

FIG. 3A depicts an example encoding process that can be executed in accordance with implementations of the present disclosure.

FIG. 3B depicts an example validation process that can be executed in accordance with implementations of the present disclosure.

FIG. 4 is a schematic illustration of example computer systems that can be used to execute implementations of the present disclosure.

Like reference symbols in the various drawings indicate like elements.

### DETAILED DESCRIPTION

Implementations of the present disclosure include computer-implemented methods for validating shipment batches using distributed ledger systems (DLSs). More particularly, implementations of the present disclosure are directed to using a DLS to validated an item based on attributes associated with the item, and one or more functions executable on the DLS. In accordance with implementations of the present disclosure, and as described in further detail herein, actions can include receiving encoded data including an attribute set and a first hash value that are unique to a unit, the encoded data being printed on the unit, determining a first validation hash value by processing the attribute set using a hash function of a smart contract executing on a DLS, comparing the first hash value and the first validation hash value to effect a comparison that indicates whether the attribute set of the unit is valid, and transmitting a message to a remote computing device, the message indicating whether the attribute set of the unit is valid.

To provide further context for implementations of the present disclosure, and as introduced above, within industry, counterfeiting of goods is problematic. For example, within the pharmaceutical industry, counterfeit pharmaceuticals is a chronic problem. This can have serious consequences. For example, a counterfeit pharmaceutical (also referred to herein as drug) may only include placebos, which can result in patients consuming such drugs not being treated for their conditions. Although various approaches seek to inhibit counterfeiting, many such approaches are ineffective to various degrees.

In a first approach, each unit (e.g., box, bottle) of drugs (e.g., in tablet form) includes specific information (defining a set of attributes) about the unit printed thereon. Example information can include, without limitation, article number (e.g., global trade item number (GTIN)), expiration date, batch/lot number, serial number, type, and the like. Wholesalers (points-of-dispense), such as pharmacies, and/or end users (e.g., consumers) can use this information to validate with the pharmaceutical company that the set of attributes is at least valid/correct. Each set of attributes is unique to a specific unit. With this first approach, however, it is still possible for a counterfeiter to duplicate one specific unit, and print the same set of attributes on all units. During validation, there will be an immediate hotspot on a specific set of attributes, but the counterfeiting is not inhibited. Consequently, the first approach is limited to enabling insight into which drugs are counterfeited in specific regions, but does not prevent the issue.

A second approach includes extension of the first approach to include a specific secret number that is printed inside the sealed unit (e.g., on a blister that contains tablets, inside the box containing the blister). This secret number can only be accessed after the seal of the box has been broken, and enables the consumer an additional level of security to validate that the secret number matches the information printed on the outside of the box. It also makes it more expensive for counterfeiters to print additional numbers inside the packaging as well. The validation process can be completed through a multitude of channels (e.g., a mobile application, a web page of the pharmaceutical company). Again, however, the second approach does not eliminate the counterfeiting.

The general problem with these approaches is that all attributes for each unit must be centrally stored, and available to the validation process. This can require large central databases to be maintained by respective companies, each with millions, billions, or even trillions of data records. Further, an underlying communication infrastructure would be required to access the central system.

In view of this, implementations of the present disclosure provide a validation platform that leverages a distributed ledger technology (DLT), such as a DLS, and smart contract technology to inhibit counterfeiting of drugs. As described in further detail herein, implementations include encoding attributes of each unit, and a hash value to provide encoded data, and using a smart contract executed on a DLS to validate the encoded data. In some implementations, the hash value is provided by an entity providing the unit using a hash function. In some examples, the encoded value includes the attributes and the hash value. The encoded data can be provided as a machine-readable code (e.g., bar code, QR code) that is printed on the unit. In some implementations, a secret value is provided within the unit.

An example DLS includes Hyperledger Fabric, which can be described as a permissioned blockchain infrastructure that provides a modular architecture, and execution of smart contracts, referred to as “chaincode.” It is contemplated, however, that any appropriate DLS, and smart contract technology can be used.

In accordance with implementations of the present disclosure, the encoded data can be validated by the smart contract on the DLS. In some implementations, the smart contract includes the same hash function used to determine the hash value. In some implementations, the DLS receives the encoded data, executes the hash function over the attributes, and determines whether the hash value provided in the encoded data is valid. If the hash value is valid, the DLS can provide a response indicating such. Likewise, if the hash value is invalid, the DLS can provide a response indicating such.

Implementations of the present disclosure are described in further detail herein with reference to an example context. The example context includes validating batches of pharmaceuticals, each batch including one or more units, each unit including a quantity of pharmaceuticals. For example, a unit can include, without limitation, a container (e.g., box, bottle, blister pack), and a quantity can include, without limitation, a number of tablets, and a fluid volume. It is contemplated, however, that implementations of the present disclosure can be realized in any appropriate context.

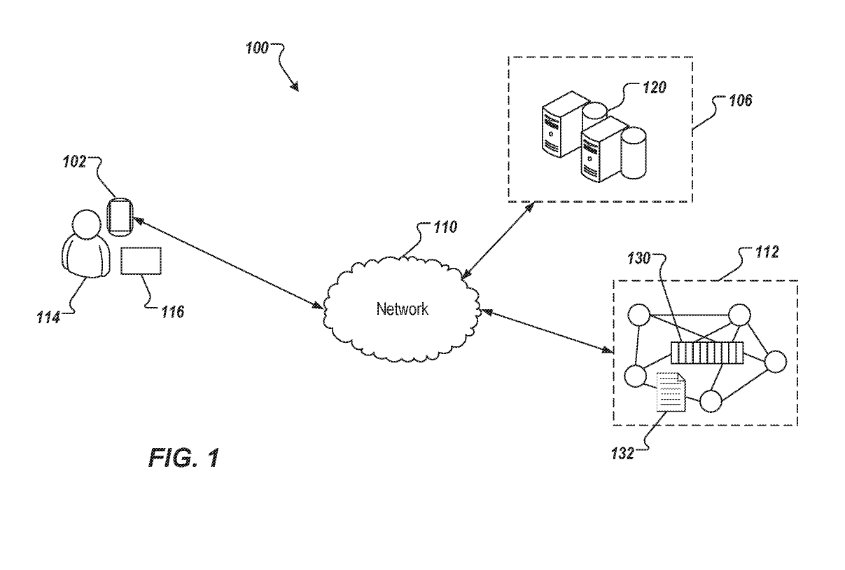

FIG. 1 depicts an example environment 100 that can be used to execute implementations of the present disclosure. In some examples, the example environment 100 enables entities (e.g., pharmaceutical companies) to provide encoded data to be printed on units, and enables downstream users (e.g., patients, wholesalers) to determine whether the encoded data is valid. The example environment 100 includes a computing device 102, a back-end system 106, a network 110, and a DLS 112. In some examples, the computing device 102 is used by a user 114 to validate the authenticity of a unit 116 (e.g., box of pharmaceuticals). For example, an entity (e.g., a pharmaceutical company) can provide the unit 116, among a plurality of units, and can encode attributes that are unique to the unit to provide encoded data. The encoded data further includes a hash value provide using a hash function, and is printed on the unit 116.

In the depicted example, the computing device 102 is provided as a mobile computing device. It is contemplated, however, that implementations of the present disclosure can be realized with any appropriate type of computing device (e.g., smartphone, tablet, laptop computer, voice-enabled devices). In some examples, the network 110 includes a local area network (LAN), wide area network (WAN), the Internet, or a combination thereof, and connects web sites, user devices (e.g., computing device 102), and back-end systems (e.g., the back-end system 106). In some examples, the network 110 can be accessed over a wired and/or a wireless communications link. For example, mobile computing devices, such as smartphones can utilize a cellular network to access the network 110.

In the depicted example, the back-end system 106 includes at least one server system 120. In some examples, the at least one server system 120 hosts one or more computer-implemented services. For example, the back-end system 106 can host computer-implemented services of an entity that provides the unit 116 (e.g., a pharmaceutical company). An example computer-implemented service can include a hash value calculation service that receives data, and processes the data through a hash function to provide a hash value. In some examples, the data can include attributes that are unique to the unit 116. Another example computer-implemented service can include a data encoding service that encodes data into a machine-readable code (e.g., bar code, QR code). In some examples, the data that is encoded includes the attributes, and the hash value.

In some examples, the computing device 102 includes a computer-executable application executed thereon, which can be used to validate the unit 116, as described herein. In some examples, the computing device 102 includes a web browser application executed thereon, which can be used to display one or more web pages to validate the unit 116, as described herein. For example, the application, and/or web browser application can enable functionality for reading the encoded data from the unit 116 (e.g., an image-based bar code scanner, or QR code reader). In some examples, the encoded data (or the decoded data including the attributes and the hash value) can be sent to the DLS for validation, as described herein.

In the depicted example, and as described in further detail herein, the DLS 112 is provided as a peer-to-peer network including a plurality of nodes that immutably record information in a ledger 130 (e.g., blockchain). Although a single ledger 130 is schematically depicted, multiple copies of the ledger 130 are provided and maintained across the DLS 112. For example, each node stores a copy of the ledger 130. In the depicted example, the DLS 112 also stores, and executes a smart contract 132, described in further detail herein. Although a single smart contract 132 is schematically depicted, multiple instances of the smart contract 132 are provided and maintained across the DLS 112. In some implementations, the smart contract 132 includes functionality for processing encoded data (or decoded data include the attributes and the hash value) provided from the computing device 102. As described in further detail herein, the smart contract 132 processes the attributes using the hash function to provide a validation hash value, and determines whether the hash value (provided from the computing device 102) matches the validation hash value.

To provide further context for the present disclosure, a high-level discussion of DLT, specifically DLS including a blockchain ledger is provided. In general, a blockchain is a ledger of all transactions that have ever been executed in one or more contexts. A blockchain constantly grows as completed blocks are added with a new set of transactions. In some examples, a single block is provided from multiple transactions (e.g., multiple transfers of resources). In general, blocks are added to the blockchain in a linear, chronological order by one or more computing devices in a peer-to-peer network of interconnected computing devices that execute a blockchain protocol. In short, the peer-to-peer network can be described as a plurality of interconnected nodes, each node being a computing device that uses a client to validate and relay transactions. Each node maintains a copy of the blockchain, which is automatically downloaded to the node upon joining the peer-to-peer network. A blockchain protocol provides a secure and reliable method of updating the blockchain, copies of which are distributed across the peer-to-peer network, without the need for a central authority.

Because all users (e.g., entities) need to know all previous transactions (e.g., resource transfers) to validate a requested transaction, all users must agree on which transactions have actually occurred, and in which order. That is, all users must come to a consensus. For example, if two users observe different transaction histories, they will be unable to come to the same conclusion regarding the validity of a transaction. In some examples, all users agree on the same rules used to validate transactions (e.g., as provided in the blockchain protocol), thus coming to a consensus. In some examples, a blockchain enables all users to come to an agreement as to transactions that have already occurred, and in which order. In short, and as described in further detail below, a ledger of transactions is agreed to based on the amount of work required to add a transaction to the ledger of transactions (e.g., add a block to the blockchain). In this context, the work is a task that can have variable difficulty (e.g., mathematically, computationally, depending on the specific implementation) for any single node (e.g., computing device) in the peer-to-peer network to quickly complete, but is relatively easy for a node (e.g., computing device) to verify.

In some DLSs, the peer-to-peer network could include so-called miners (e.g., computing devices) that add blocks to a blockchain based on the blockchain protocol. In general, multiple miners validate transactions that are to be added to a block, and compete (e.g., perform work, as introduced above) to have their block added to the blockchain. Validation of transactions includes verifying digital signatures associated with respective transactions. For a block to be added to the blockchain, a miner must demonstrate a proof of work before their proposed block of transactions is accepted by the peer-to-peer network, and is added to the blockchain.

In accordance with a blockchain protocol, for example, each miner in the peer-to-peer network receives transaction information for one or more transactions that are to be included in a block that is to be added next in the blockchain. Each miner provides the reference to the previous (most recent) block in the blockchain, details of the transaction(s) that are to be included in the to be created block, and the nonce value to a cryptographic hash function (CHF) to provide a hash value. If the hash value does not meet the threshold hash (e.g., the first four characters of the hash value are not each zero), the miner starts again to provide another hash value. If the hash value meets the threshold hash (e.g., at least the first four characters of the hash value are each zero), the respective miner successfully created the next block that is to be added to the blockchain. Consequently, the respective miner's block is broadcast across the peer-to-peer network. All other miners cease work (because one miner was already successful, and all other miners accept that block as valid), and all copies of the blockchain are updated across the peer-to-peer network to append the block to the blockchain. Each miner may be required to produce hundreds or thousands (or even millions, billions, or trillions) of hash values, before any one miner provides a qualifying hash value.

To provide further context for the present disclosure, a high-level discussion of smart contract technology is provided. In general, a smart contract includes computer-executable code that is executed on a DLS, and performs programmed functionality. The smart contract can be programmed in any appropriate programming language, such as Go, provided by Google, Inc. of Mountain View, Calif. In the instant context, the smart contract is programmed to receive attributes, and a hash value, and generate a validation hash value by processing the attributes through a hash function to validate the hash value. In some examples, the smart contract is programmed to decode encoded data (e.g., decode a machine-readable code) to determine the attributes, and the hash value. For example, the smart contract can receive an image of a machine-readable code, and con process the image to decode the encoded data.

In accordance with implementations of the present disclosure, a unit (e.g., box) of a to-be-validated item (e.g., pharmaceutical) is associated with a set of attributes. Example attributes can include, without limitation, article number (e.g., GTIN), expiration date, batch/lot number, serial number, type, and the like. In some implementations, a hash function (F) is used to provide a hash value (H1). In general, the hash function (F) can include, without limitation, maps data (e.g., attributes) of arbitrary size to data of a fixed size. An example hash function includes, without limitation, the 256-bit (32 byte) secure hash algorithm 256 (SHA-256).

In some implementations, the hash value (H1) is a hash of the attributes. That is, for example, the attributes (e.g., a concatenation of the attributes) are processed through the hash function (F) to provide the hash value (H1). In some examples, during production, an entity providing the unit assigns the attributes to the unit, and determines the hash value (H1). For example, the back-end system 106 of FIG. 1 can be operated by, or on behalf of an entity providing the units, and can determine hash value (H1) using the hash function (F). The attributes, and consequently the hash value, are unique to a respective unit. The attributes and the hash value are encoded to provide encoded data. For example, the attributes and the hash value can be encoded (e.g., by the back-end system 106) into a machine-readable code (e.g., a bar code, a QR code). The encoded data is printed on the respective unit (e.g., printed as a machine-readable code on the unit).

The same hash function (F) is provided in a smart contract on a DLS (e.g., the smart contract 132 on the DLS 112). In this manner, and as described herein, the smart contract can process the attributes to provide validation hash values that can be compared to hash values of the units.

In some implementations, the hash function (F) is a public hash function (FPUB). That is, for example, the public hash function can be one of numerous hash functions generally known to the public, not secret. However, only the entity that provides the units (e.g., a pharmaceutical company) knows exactly which hash function is used. Consequently, a counterfeiter would have difficulty guessing the hash function to recreate the process.

In some implementations, the hash function (F) is a hash function that uses a private salt value (S) to determine the hash value. That is, for example, the private hash function can be one of numerous hash functions generally known, but the salt value is secret. Accordingly, F_{PRIV} is used to denote this hash function herein. Only the entity that provides the units (e.g., a pharmaceutical company) knows which salt value that is used. Consequently, a counterfeiter would have difficulty not only guessing the hash function that was used, but also guessing the salt value (S). In the case of the hash function F_{PRIV}, the smart contract is also programmed with the secret salt value.

In some implementations, a secret number is associated with the attributes of a respective unit. For example, the secret number can be unique to the attributes of the respective unit, and consequently, also unique to the unit. In some implementations, the secret number is provided as a second hash value (H2) (e.g., using the same hash function F as for the hash value H1, or a different hash function). The second hash value is encoded to provide encoded data (e.g., as a machine-readable code), and is printed on the unit. For example, the encoded data can be printed inside the unit (e.g., cannot be determined without first opening the unit). The encoded data can be printed on the inside of a box, and/or on blister packs within the box. In the case of a secret number, validation is performed based on the hash value (H1), and the second hash value (H2).

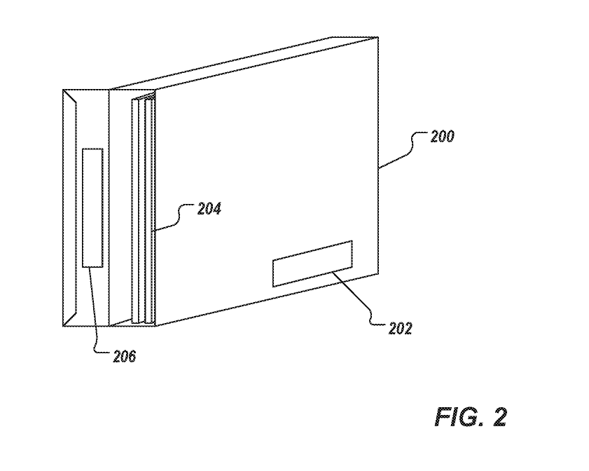

FIG. 2 depicts an example unit 200 having attributes encoded in a machine-readable code 202 printed thereon in accordance with implementations of the present disclosure. In the depicted example, the unit 200 contains a plurality of blister packs 204. In some examples, the blister packs 204 each store a quantity of a pharmaceutical (e.g., tablets). As described herein, the machine-readable code 202 encodes attributes associated with the pharmaceutical. In some examples, the machine-readable code 202 is provided as a bar code, or a QR code.

In some examples, the machine-readable code 202 can be read (e.g., by a computing device), which can decode the encoded data to determine the attributes, and the hash value (H1), and send the attributes, and the hash value (H1) to the DLS for execution of the validation process. In some examples, an image of the machine-readable code 202 is captured (e.g., by a computing device), and the image is sent to the DLS for execution of the validation process. For example, the smart contract decodes the encoded data from the image of the machine-readable code.

In some implementations, and as described herein, a second hash value (H2) can be provided. In the example of FIG. 2, a machine-readable code 206 is provided (e.g., on the inside of the unit 200), which encodes the second hash value (H2). In some examples, and as described herein, the second hash value (H2) is optional.

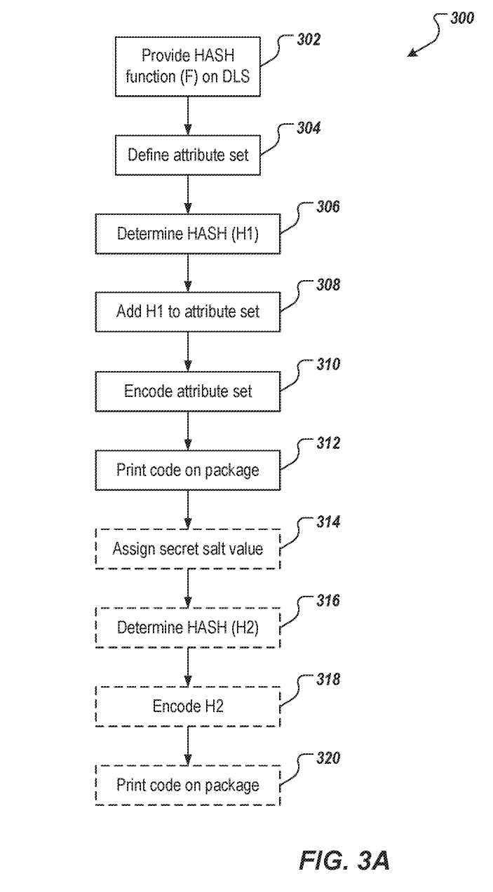

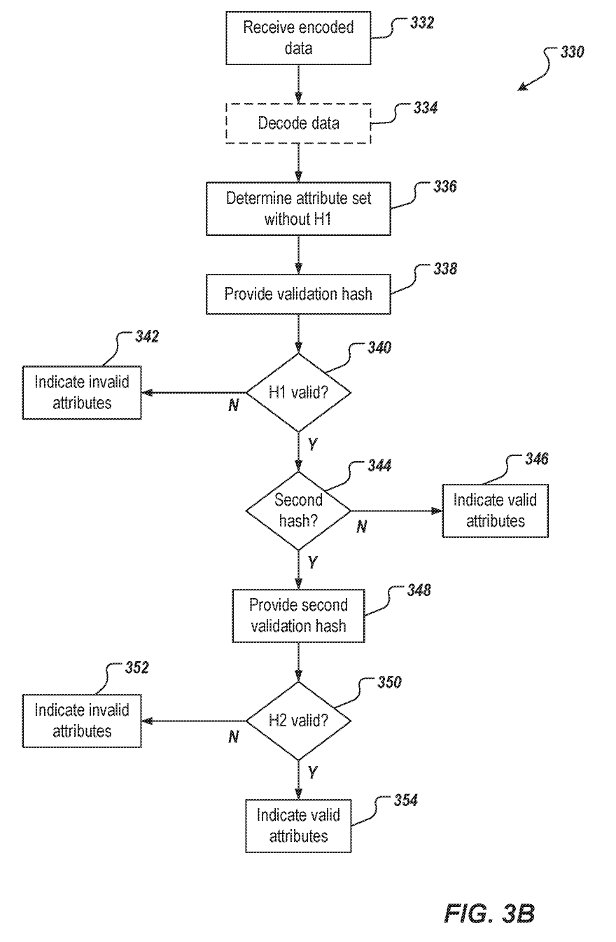

FIG. 3A depicts an example encoding process that can be executed in accordance with implementations of the present disclosure. In some implementations, the example process 300 may be performed using one or more computer-executable programs executed using one or more computing devices.

A hash function (F) is provided on a DLS (302). For example, an entity providing units of a product (e.g., pharmaceuticals) can determine a hash function (F) that is to be used. In addition to local execution of the hash function (F) to provide hash values for units, the hash function (F) is programmed into a smart contract that is executed on a DLS. An attribute set is defined (304). For example, for a respective unit, an attribute set is provided, which is unique to the respective unit. Example attributes can include, without limitation, article number (e.g., GTIN), expiration date, batch/lot number, serial number, type, and the like.

A hash value (H1) is determined (306). For example, the hash function (F) locally processes (e.g., on a server system owned by, or operated on behalf of the entity) to provide the hash value (H1). The hash value (H1) is added to the attribute set (308), and the attribute set is encoded (310). For example, the attribute set is encoded into a machine-readable code (e.g., bar code, QR code). The machine-readable code is printed on the unit (312). For example, the machine-readable code is printed on the exterior of the unit.

In some implementations, and as an option (indicated by dashed lines), a secret salt value is assigned (314). In some examples, the secret salt value is used for a particular day, week, month, year, and/or batch. In this manner, the secret salt value is unique to a set of units of the product, as opposed to being unique to each individual unit. In this manner, maintenance and storage of potentially millions of secret salt values can be avoided. A second hash value (H2) is determined (316). For example, the hash function locally processes the secret salt value to provide the second hash value (H2). In some examples, the hash function used to determine the second hash value (H2) is the same hash function used to determine the first hash value (H1). In some examples, if a secret salt value is used to determine the first hash value (H1), a different secret salt value is sued to determine the second hash value (H2). The second hash value (H2) is encoded (318). For example, the second hash value (H2) is encoded into a machine-readable code (e.g., bar code, QR code). The machine-readable code is printed on the unit (320). For example, the machine-readable code is printed on the interior of the unit. In this manner, the interior-placed machine-readable code is only viewable, if the unit is open.

FIG. 3B depicts an example validation process 320 that can be executed in accordance with implementations of the present disclosure. In some implementations, the example process 320 may be performed using one or more computer-executable programs executed using one or more computing devices.

Encoded data is received (332). For example, encoded data can be provided to the DLS, the smart contract in particular from a remote computing device (e.g., through an application program interface (API)). The encoded data can be decoded (334). For example, if the encoded data is received as an image of a machine-readable code, the machine-readable code can be decoded to provide the attribute set, which includes the hash value therein. As another example, the encoded data is determined from an image of the machine-readable code prior to being sent to the DLS.

The attribute set is determined (336). That is, for example, the hash value (H1) is separate from the attribute set, such that the original attribute set remains. A validation hash value is provided (338). For example, the smart contract processes the attribute set using the hash function (F) to provide the validation hash value. It is determined whether the hash value (H1) is valid (340). For example, the hash value (H1) is compared to the validation hash value. If the hash value (H1) is identical to the validation hash value, the hash value (H1) is determined to be valid. If the hash value (H1) is not identical to the validation hash value, the hash value (H1) is determined to be invalid.

If the hash value (H1) is invalid, an indication is provided that the attributes are invalid (342). For example, a message can be transmitted to a user that submitted the encoded data for validation, the message indicating that the attributes associated with the unit are invalid (i.e., the unit in question is likely counterfeit).

If the hash value (H1) is valid, it can be determined whether a secret number is used (344). For example, and as described above, use of a secret number for a second level of surety can be optionally implemented. If a secret number is not used, an indication is provided that the attributes are valid (346). For example, a message can be transmitted to a user that submitted the encoded data for validation, the message indicating that the attributes associated with the unit are valid (i.e., the unit in question is authentic (not counterfeit)).

If a second hash value is used (e.g., printed on the inside of the package), a second validation hash value is determined (348). For example, the smart contract can process the second hash value (H2) (e.g., determined from a machine-readable code printed on the interior of the unit) using the hash function (F) to determine the second validation hash value. It is determined whether the second hash value (H2) is valid (350). For example, the hash value (H2) is compared to the second validation hash value. If the hash value (H2) is identical to the second validation hash value, the hash value (H2) is determined to be valid. If the hash value (H2) is not identical to the second validation hash value, the hash value (H2) is determined to be invalid. If the second hash value (H2) is invalid, an indication is provided that the attributes are invalid (352). For example, a message can be transmitted to a user that submitted the encoded data for validation, the message indicating that the attributes associated with the unit are invalid (i.e., the unit in question is likely counterfeit). If the second hash value (H2) is valid, an indication is provided that the attributes are valid (354). For example, a message can be transmitted to a user that submitted the encoded data for validation, the message indicating that the attributes associated with the unit are valid (i.e., the unit in question is authentic (not counterfeit)).

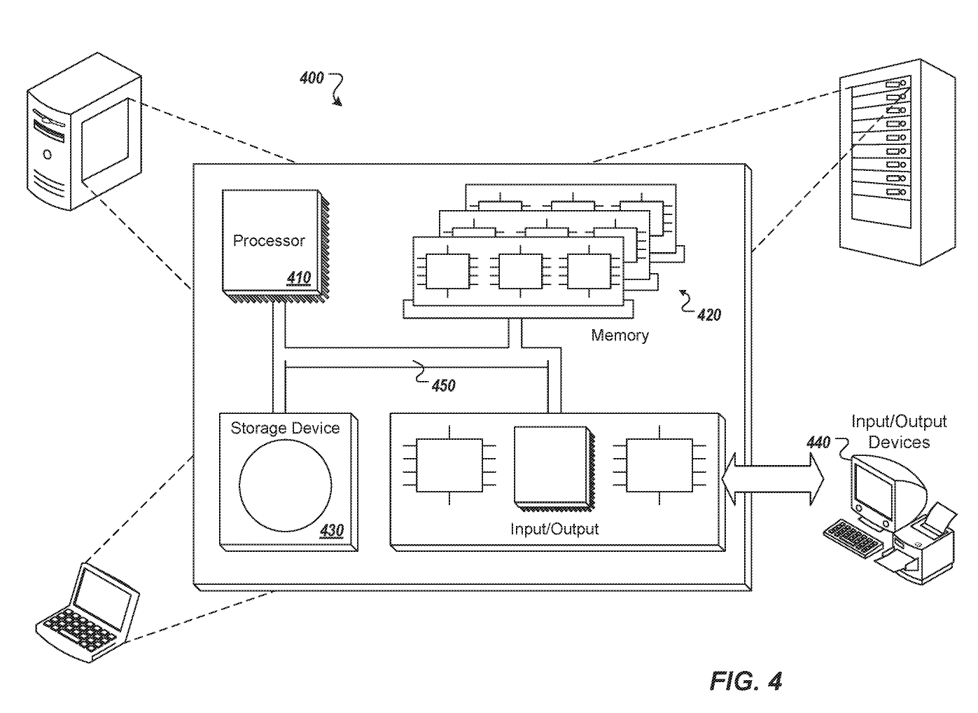

FIG. 4 depicts a schematic diagram of an example computing system 400. The system 400 may be used to perform the operations described with regard to one or more implementations of the present disclosure. For example, the system 400 may be included in any or all of the server components, or other computing device(s), discussed herein. The system 400 may include one or more processors 410, one or more memories 420, one or more storage devices 430, and one or more input/output (I/O) devices 440. The components 410, 420, 430, 440 may be interconnected using a system bus 450.

The processor 410 may be configured to execute instructions within the system 400. The processor 410 may include a single-threaded processor or a multi-threaded processor. The processor 410 may be configured to execute or otherwise process instructions stored in one or both of the memory 420 or the storage device 430. Execution of the instruction(s) may cause graphical information to be displayed or otherwise presented via a user interface on the I/O device 440.

The memory 420 may store information within the system 400. In some implementations, the memory 420 is a computer-readable medium. In some implementations, the memory 420 may include one or more volatile memory units. In some implementations, the memory 420 may include one or more non-volatile memory units.

The storage device 430 may be configured to provide mass storage for the system 400. In some implementations, the storage device 430 is a computer-readable medium. The storage device 430 may include a floppy disk device, a hard disk device, an optical disk device, a tape device, or other type of storage device. The I/O device 440 may provide I/O operations for the system 400. In some implementations, the I/O device 440 may include a keyboard, a pointing device, or other devices for data input. In some implementations, the I/O device 440 may include output devices such as a display unit for displaying graphical user interfaces or other types of user interfaces.

The features described may be implemented in digital electronic circuitry, or in computer hardware, firmware, software, or in combinations of them. The apparatus may be implemented in a computer program product tangibly embodied in an information carrier (e.g., in a machine-readable storage device) for execution by a programmable processor; and method steps may be performed by a programmable processor executing a program of instructions to perform functions of the described implementations by operating on input data and generating output. The described features may be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that may be used, directly or indirectly, in a computer to perform a certain activity or bring about a certain result. A computer program may be written in any form of programming language, including compiled or interpreted languages, and it may be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. Elements of a computer may include a processor for executing instructions and one or more memories for storing instructions and data. Generally, a computer may also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory may be supplemented by, or incorporated in, application-specific integrated circuits (ASICs).

To provide for interaction with a user, the features may be implemented on a computer having a display device such as a cathode ray tube (CRT) or liquid crystal display (LCD) monitor for displaying information to the user and a keyboard and a pointing device such as a mouse or a trackball by which the user may provide input to the computer.

The features may be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system may be connected by any form or medium of digital data communication such as a communication network. Examples of communication networks include, e.g., a local area network (LAN), a wide area network (WAN), and the computers and networks forming the Internet.

The computer system may include clients and servers. A client and server are generally remote from each other and typically interact through a network, such as the described one. The relationship of client and server arises by virtue of computer programs running on the respective computers and having a client-server relationship to each other.

In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

A number of implementations of the present disclosure have been described. Nevertheless, it will be understood that various modifications may be made without departing from the spirit and scope of the present disclosure. Accordingly, other implementations are within the scope of the following claims.

What is claimed is:

1. A computer-implemented method executed by one or more processors for authenticating units of products, the method comprising:
receiving, by the one or more processors, encoded data including an attribute set and a first hash value that are unique to a unit, the encoded data being printed on the unit;
determining, by the one or more processors, a first validation hash value by processing the attribute set using a hash function of a smart contract executing on a distributed ledger system (DLS);
comparing, by the one or more processors, the first hash value and the first validation hash value to effect a comparison that indicates whether the attribute set of the unit is valid; and
transmitting, by the one or more processors, a message to a remote computing device, the message indicating whether the attribute set of the unit is valid.

2. The method of claim 1, wherein the first hash value is provided by locally processing the attribute set using the hash function.

3. The method of claim 1, wherein the encoded data includes the first hash value included in the attribute set.

4. The method of claim 1, wherein the encoded data is provided as a machine-readable code that is printed on the unit.

5. The method of claim 1, wherein the hash function is a public hash function that provides the first hash value, and the first validation hash value based on a secret salt value.

6. The method of claim 1, further comprising determining a second validation hash value using the smart contract executing on the DLS, wherein validity of the attribute set if further based on comparing a second hash value and the second validation hash value.

7. The method of claim 1, wherein the attribute set comprises two or more of an article number, an expiration date, a batch number, a serial number, and a type.

8. A non-transitory computer-readable storage medium coupled to one or more processors and having instructions stored thereon which, when executed by the one or more processors, cause the one or more processors to perform operations for authenticating units of products, the operations comprising:
receiving encoded data including an attribute set and a first hash value that are unique to a unit, the encoded data being printed on the unit;
determining a first validation hash value by processing the attribute set using a hash function of a smart contract executing on a distributed ledger system (DLS);
comparing the first hash value and the first validation hash value to effect a comparison that indicates whether the attribute set of the unit is valid; and
transmitting a message to a remote computing device, the message indicating whether the attribute set of the unit is valid.

9. The computer-readable storage medium of claim 8, wherein the first hash value is provided by locally processing the attribute set using the hash function.

10. The computer-readable storage medium of claim 8, wherein the encoded data includes the first hash value included in the attribute set.

11. The computer-readable storage medium of claim 8, wherein the encoded data is provided as a machine-readable code that is printed on the unit.

12. The computer-readable storage medium of claim 8, wherein the hash function is a public hash function that provides the first hash value, and the first validation hash value based on a secret salt value.

13. The computer-readable storage medium of claim 8, wherein operations further comprise determining a second validation hash value using the smart contract executing on the DLS, wherein validity of the attribute set if further based on comparing a second hash value and the second validation hash value.

14. The computer-readable storage medium of claim 1, wherein the attribute set comprises two or more of an article number, an expiration date, a batch number, a serial number, and a type.

15. A system, comprising:
a computing device; and
a computer-readable storage device coupled to the computing device and having instructions stored thereon which, when executed by the computing device, cause the computing device to perform operations for authenticating units of products, the operations comprising:
receiving encoded data including an attribute set and a first hash value that are unique to a unit, the encoded data being printed on the unit;
determining a first validation hash value by processing the attribute set using a hash function of a smart contract executing on a distributed ledger system (DLS);
comparing the first hash value and the first validation hash value to effect a comparison that indicates whether the attribute set of the unit is valid; and
transmitting a message to a remote computing device, the message indicating whether the attribute set of the unit is valid.

16. The system of claim 15, wherein the first hash value is provided by locally processing the attribute set using the hash function.

17. The system of claim 15, wherein the encoded data includes the first hash value included in the attribute set.

18. The system of claim 15, wherein the encoded data is provided as a machine-readable code that is printed on the unit.

19. The system of claim 15, wherein the hash function is a public hash function that provides the first hash value, and the first validation hash value based on a secret salt value.

20. The system of claim 15, wherein operations further comprise determining a second validation hash value using the smart contract executing on the DLS, wherein validity of the attribute set if further based on comparing a second hash value and the second validation hash value.
